(19) United States
(12) Patent Application Publication
(10) Pub. No.: US 2020/0088871 A1
(43) Pub. Date: Mar. 19, 2020

(54) WIRELESS RADAR LEVEL GAUGE

(71) Applicant: Rosemount Tank Radar AB, Molnlycke (SE)

(72) Inventor: Tomas Wennerberg, Kallered (SE)

(21) Appl. No.: 16/134,214

(22) Filed: Sep. 18, 2018

(51) Int. Cl. G01S 13/88; G01F 23/284; G01S 7/00

(52) U.S. Cl. CPC G01S 13/88; G01S 7/003; G01F 23/284

(57) ABSTRACT

The present invention relates to a radar level gauge (10) for determining a filling level (L) of a product in a tank, said radar level gauge comprising a Bluetooth communication unit, wherein the Bluetooth protocol is the sole communication protocol of the radar level gauge, and wherein the radar level gauge is devoid of any communication terminal(s) and associated components adapted to connect the radar level gauge to an external communication device via at least one communication wire.

### FIELD OF THE INVENTION

The present invention relates to a radar level gauge for determining a filling level of a product in a tank. The present invention also relates to a system i.a. comprising a plurality of such radar level gauges, and to a method of wirelessly sending a determined filling level of a product in a tank from a radar level gauge to another unit.

### BACKGROUND OF THE INVENTION

Radar level gauges can nowadays communicate measurement data wirelessly using the WirelessHART communication protocol. WirelessHART was defined for the requirements of process field device networks, and was introduced to the market in 2007.

An example of a radar level gauge using WirelessHART is the Rosemount 3308 Wireless Level Transmitter. Rosemount 3308 Wireless Level Transmitter may send data wirelessly to a gateway, directly or routed through any of the wireless devices in the network. The Rosemount 3308 Wireless Level Transmitter is powered by a power module comprising two batteries. Furthermore, the Rosemount 3308 Wireless Level Transmitter has communication terminals utilized when the transmitter joins the wireless network. Namely, an operator connects a Field Communicator or a HART modem to the communication terminals of the transmitter, and then performs a number of steps to obtain network ID and join key, enter network ID and join key, and verify that the transmitter joins the network. Thereafter, the Field Communicator or a HART modem can be disconnected.

Furthermore, DE102006062476 (A1) discloses a radio field device which has a sensor unit for detecting a chemical or physical measurement variable and a radio unit, which is connected with the sensor unit. The radio unit has two radio modules. The first radio module can be a HART radio module, and the second radio module is a Bluetooth module. The second radio module is used to transmit i.a. configuration data.

Other devices using Bluetooth are the Radar measurement Time-of-Flight Micropilot FRM10 and FMR20 from Endress+Hauser. Micropilot FRM10 and FMR20 are wired devices and communicate measured values via the wires (4-20 mA and HART), but also allows wireless remote access via Bluetooth, including commissioning, using an app.

While the above-described devices may be useful, there is still room for improvement when it comes to manufacturing cost and simplicity in construction and use.

### General Disclosure of the Invention

It is an object of the present invention to provide an improved radar level gauge, in particular when it comes to manufacturing cost and/or simplicity in construction and use.

According to a first aspect of the present invention, this and other objects are achieved by a radar level gauge for determining a filling level of a product in a tank, said radar level gauge comprising: transceiver circuitry configured to generate and transmit an electromagnetic transmit signal, and to receive an electromagnetic return signal; processing circuitry connected to the transceiver circuitry and configured to determine the filling level based on a relationship between the transmit signal and the return signal; a Bluetooth communication unit, wherein the Bluetooth communication unit is connected to the processing circuitry and configured to wirelessly send a determined filling level to an external unit using a Bluetooth protocol; and means for supplying power to the transceiver circuitry, the processing circuitry and the Bluetooth communication unit, wherein the Bluetooth protocol is the sole communication protocol of the radar level gauge, and wherein the radar level gauge is devoid of any communication terminal(s) and associated components adapted to connect the radar level gauge to an external communication device via at least one communication wire.

The ‘external unit’ may be a gateway or another radar level gauge according to the first aspect, for example. The ‘external communication device’ could be a Tank Hub or Field Communication Unit, for example. The ‘associated components’ of the communication terminal(s) may include physical layer electronics, such as pre-regulator, analog out, circuitry for feedback control loops, etc., as well a dedicated HART/FF modem.

The present invention is based on the understanding that new capabilities introduced with the new Bluetooth 5 standard makes it possible and feasible to use Bluetooth as the one and only communication protocol of a radar level gauge, in particular for sending determined filling levels but also for receiving other data, such as control data and/or configuration data. This may reduce the cost of the radar level gauge, since Bluetooth chips are readily available at a relatively low price. Also, the inventor has realized that contrary to what is customary in radar level gauging, no other radio or communication terminal(s) for connecting the radar level gauge to an external communication device are needed, whereby the construction may be simplified, and the cost of the radar level gauge can be reduced even further. Also, since no communication wires are needed, installation of the radar level gauge may be simplified. Also, since there is no communication terminal and associated components, maintenance may be reduced, as the radar level gauge has one less thing that can malfunction. Furthermore, the present radar level gauge avoids that the reliability of the measurement signal is affected and that digital communication fails doe to corrosion in the terminal compartment where communication terminals usually are situated.

The new capabilities introduced with the new Bluetooth 5 standard include longer range, faster communication, and support for mesh network.

It should be noted that the above-described DE102006062476 (A1), Micropilot FRM10 and Micropilot FMR20 all have dual communication protocols: (wireless) HART and Bluetooth in DE102006062476 (A1), 4-20 mA and Bluetooth in Micropilot FRM10, and (wired) HART and Bluetooth in Micropilot FRM20. Also, Bluetooth is in DE102006062476 (A1), Micropilot FRM10 and Micropilot FMR20 used as a secondary communication channel, rather as the one and only communication channel like in the present invention.

The Bluetooth communication unit preferably has mesh capability. This may extend the range, as determined filling levels can be sent via one or more other radar level gauges to a gateway. Without mesh capability, point-to-point could be used.

The transceiver circuitry and processing circuitry may be integrated in a single integrated circuit, either as a monolithic IC or as a hybrid multichip IC. This may be referred to as Radar-On-A-Chip (ROAC). The cost of a Radar-On-A-Chip may be relatively low, as it can be based on mass produced radars for the automotive industry, whereby the cost of the radar level gauge can be reduced even further, providing an unimaginable overall cost efficient design of the present radar level gauge.

The Bluetooth communication unit may be provided on a separate chip, i.e. not the same chip as the transceiver circuitry and processing circuitry. This may offer a cost advantage, since there is a large market for (separate) radar chips and a large market for (separate) Bluetooth chips, making separate chips cheap and readily available.

The Bluetooth communication unit may include provisioning capability allowing the radar level gauge to wirelessly join a Bluetooth mesh network. In this way, there is no need to connect the present radar level gauge with wires to a Field Communicator or a HART modem, like the Rosemount 3308 Wireless Level Transmitter, and communication terminals and associated components can be dispensed with, as discussed above. The provisioning may be performed in accordance with the Bluetooth mesh networking specification.

The Bluetooth communication unit is preferably a Bluetooth Low Energy (BLE) communication unit, with relatively low power consumption.

Said means for supplying power to the transceiver circuitry, processing circuitry and the Bluetooth communication unit may include a battery. This provides for a completely wireless radar level gauge. The battery could be placed inside the radar level gauge's housing, or it could be placed in a power module removably connected to the radar level gauge.

The means for supplying power to the transceiver circuitry, processing circuitry and the Bluetooth communication unit could alternatively include at least one power supply terminal adapted to connect the radar level gauge to an external power supply via at least one power supply wire (i.e. “line power”). Since there is no communication via such terminal(s) of the present radar level gauge, the conventional components associated with wired communication via the terminal(s) and typically arranged inside the radar level gauge may be omitted, as discussed above. Also, the requirements for the power consumption may be simplified, and the radar level gauge can get more energy compared to HART 4-20 mA, which in turn can improve the performance. Furthermore, the Ex barrier configuration of the radar level gauge may be substantially facilitated, since just two or three input voltage levels (with associated barriers) may be needed.

According to a second aspect of the present invention, there is provided a system, comprising: a gateway; and a plurality of radar level gauges according to the first aspect, wherein the Bluetooth communication unit of each radar level gauge of the plurality of radar level gauges has mesh capability, and wherein the gateway and the plurality of radar level gauges form a Bluetooth mesh network. The ‘external unit’ mentioned in conjunction with the first aspect is here the gateway, and the Bluetooth communication unit is configured to wirelessly send a determined filling level to the gateway using a Bluetooth protocol, directly and/or via at least one other radar level gauge of the plurality of radar level gauges. This aspect may exhibit the same or similar features and technical effects as the first aspect, and vice versa.

The Bluetooth mesh network may also comprise at least one field device which is not a radar level gauge but which otherwise has the same or similar configuration as the present radar level gauge, in particular when it comes to communication capability. In view of this, there is envisaged a (separate) field device comprising: means for determining or measuring at least one process variable; a Bluetooth communication unit with mesh capability, wherein the Bluetooth communication unit is connected to said means for determining or measuring at least one process variable and configured to wirelessly send at least one determined or measured process variable to an external unit using a Bluetooth protocol; and means for supplying power to said means for determining or measuring at least one process variable and the Bluetooth communication unit, wherein the Bluetooth protocol is the sole communication protocol of the field device, and wherein the field device is devoid of any communication terminal(s) and associated components adapted to connect the device to an external communication device via at least one communication wire. The at least one process variable may be at least one of: temperature, pressure, flow rate, and pH, and said means for determining or measuring at least one process variable may include at least one of: a temperature gauge, a pressure gauge, a flowmeter, and a pH-meter.

The gateway may be configured to receive determined filling levels from the plurality of radar level gauges via Bluetooth, and to convert the received determined filling levels to at least one other communication protocol selected from the group comprising: FF (Foundation Fieldbus), HART (Highway Addressable Remote Transducer), Modbus, Modbus TCP, Profibus, Ethernet, cellular network (e.g. 4G or 5G), and OPC (Open Platform Communications). These are communication protocols already used in the process industry. Hence, the gateway may be readily connected to existing infrastructure without having to modify that infrastructure. The gateway may for example contain or have access to a table wherein Bluetooth IDs of the radar level gauges are mapped to addresses of another communication protocol selected from the aforementioned group. The table and mapping may be programmed by a user. For example, for Modbus, the gateway may list the available radar level gauges and any other field devices on the Bluetooth mesh network, wherein the user enters which Modbus address to use for each gauge/device. Determined filling levels and other process variables can then become available in predefined or custom Modbus registers, and a Modbus client can access information from the gateway by reading Modbus registers for different addresses.

To this end, there is envisaged a (separate) gateway comprising a Bluetooth communication unit with mesh capability for connecting the gateway to a Bluetooth mesh network comprising a plurality of radar level gauges (according to the first aspect), wherein the gateway is configured to receive determined filling levels from the plurality of radar level gauges via the Bluetooth mesh network by means of its Bluetooth communication unit, and to convert the received determined filling levels to at least one other communication protocol, preferably selected from the group comprising: FF, HART, Modbus, Modbus TCP, Profibus, Ethernet, cellular network, and OPC. The gateway may further be configured to send the convert received determined filling levels to another unit (e.g. a Distributed Control System (DCS)) or to a cloud solution using the at least one other communication protocol. The gateway could also send to the cloud solution via for example HTTP or MQTT (application layer) and TCP/UDP (transport layer).

The system may further comprise a mobile device configured to establish a secondary temporary communication channel via Bluetooth with the Bluetooth communication unit of a radar level gauge of the plurality of radar level gauges. In this way, the radar level gauge could be accessed in the field using for example an app in the mobile device, although without the need to connect any wire(s) or utilizing some other communication protocol. The secondary temporary communication channel could be established directly with the radar level gauge, or via one or more neighboring radar level gauges in the Bluetooth mesh network. The latter means that the mobile device does not have to be so physically close to the radar level gauge one wants to communicate with, which can be advantageous in a difficult to access field environment.

The system may further comprise another gateway forming another Bluetooth mesh network with at least some radar level gauges of the plurality of radar level gauges. The another gateway may be acting as a redundant gateway, or as a display unit, for example.

The system may further comprise a passive device connected via Bluetooth to the Bluetooth mesh network and adapted to (just) listen to communication in the Bluetooth mesh network. The passive device may for example be a display unit adapted to display determined filling levels from one or more of the radar level gauges of the Bluetooth mesh network.

According to a third aspect of the present invention, there is provided a method of wirelessly sending a determined filling level of a product in a tank from a radar level gauge according to the first aspect to another unit, wherein the method comprises: by means of the Bluetooth communication unit, wirelessly sending a determined filling level to the another unit using a Bluetooth protocol. The ‘external unit’ mention in conjunction with the first aspect is here the ‘another unit’, which may be a gateway or another radar level gauge according to the first aspect, for example. This aspect may exhibit the same or similar features and technical effects as the first and/or second aspects, and vice versa.

### BRIEF DESCRIPTION OF THE DRAWINGS

The present invention will be described in more detail with reference to the appended drawings, showing currently preferred embodiments of the invention.

FIG. 1 schematically illustrates a radar level gauge according to an embodiment of the present invention.

FIG. 2 schematically illustrates the radar level gauge of FIG. 1 in conjunction with a tank.

FIG. 3 schematically illustrates a system according to an embodiment of the present invention.

FIG. 4 schematically illustrates a field device which may be included in the system of FIG. 3.

FIG. 5a-c illustrate variants of the system of FIG. 3.

### DETAILED DESCRIPTION OF PREFERRED EMBODIMENTS

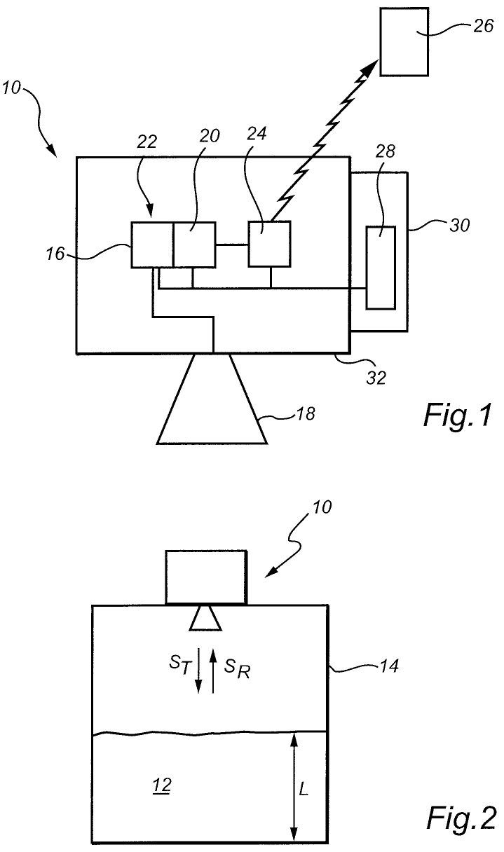

A radar level gauge 10 for determining a filling level L of a product 12 in a tank 14 according to an embodiment of the present invention is shown in FIGS. 1-2. The radar level gauge 10 is adapted to be mounted, and is in use typically mounted, on the roof of the tank 14, as shown in FIG. 2.

The radar level gauge 10 comprises transceiver circuitry 16 configured to generate and transmit an electromagnetic transmit signal S_{T}, and to receive an electromagnetic return signal SR, preferably via a signal propagation device 18 of the radar level gauge 10. The signal propagation device 18 may be an antenna (for non-contacting radar such as pulse radar or FMCW) or a probe (for guided wave radar), for example.

The radar level gauge 10 further comprises processing circuitry 20 connected to the transceiver circuitry 16 and configured to determine the filling level L based on a relationship between the transmit signal and the return signal.

The transceiver circuitry 16 and processing circuitry 20 are preferably integrated in a single integrated circuit 22, either as a monolithic IC or as a hybrid multichip IC. This may be referred to as Radar-On-A-Chip (ROAC).

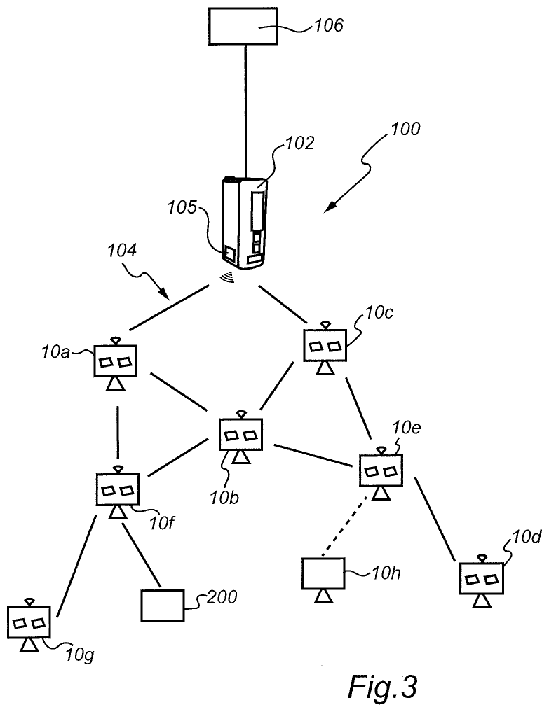

The radar level gauge 10 further comprises a Bluetooth communication unit 24 with mesh capability. The mesh capability enables many-to-many device communications, as will be will be discussed further in relation to FIG. 3. The Bluetooth communication unit 24 may for example be a Bluetooth 5 communication unit. Furthermore, the Bluetooth communication unit 24 is preferably a Bluetooth Low Energy (BLE) communication unit, and it may be provided as a separate chip. The Bluetooth communication unit 24 may for example be, or be based on, a SimpleLink Bluetooth 5.0 low energy Wireless MCU provided by Texas Instruments.

The Bluetooth communication unit 24 is connected to the processing circuitry 20, and it is configured to wirelessly send filling levels determined by the processing circuitry 20 to a non-human unit 26 external of the radar level gauge 10 using a Bluetooth protocol. The non-human unit 26 may for example be a gateway 102 or another radar level gauge 10 (see FIG. 3). The Bluetooth protocol is the sole communication protocol of the radar level gauge 10, wherein a ‘communication protocol’ may be defined as a set of conventions governing the treatment and especially the formatting of data in an electronic communications system. It is however not ruled out that the radar level gauge 10 also could have a display (not shown) adapted to display e.g. the determined filling level L.

The Bluetooth communication unit 24 may also be configured to receive control data and/or configuration data for the radar level gauge 10

The radar level gauge 10 further comprises means for supplying power to the transceiver circuitry 16, the processing circuitry 20 and the Bluetooth communication unit 24. Said means may include at least one battery 28 which may be placed in a power module 30 removably connected to a housing 32 of the radar level gauge 10.

The radar level gauge 10 is further devoid of any communication terminal(s) for connecting the radar level gauge 10 to an external communication device via at least one communication wire. In other words, the radar level gauge 10 does not have any physical communication terminal(s), for example on the outside of the housing 32. Also, the radar level gauge 10 does not have (electronic) components typically associated with such communication terminal(s), including physical layer electronics and a dedicated modem.

In operation, the Bluetooth communication unit 24 of the radar level gauge 10 wirelessly sends at least one determined filling level to the unit 26 using the Bluetooth protocol. The at least one determined filling level may be determined by the processing circuitry 20 of the radar level gauge 10, but the Bluetooth communication unit 24 may also relay determined filling levels from other radar level gauges 10, as will be discussed further in relation to FIG. 3.

FIG. 3 shows a system 100 comprising a gateway 102 and a plurality of radar level gauges 10 according to the first aspect of the present invention. The gateway 102 and the plurality of radar level gauges 10a-g form a Bluetooth mesh network 104. The gateway 102 comprises a Bluetooth communication unit 105 with mesh capability for connecting the gateway to the Bluetooth mesh network 104, and it is generally configured to receive determined filling levels from the plurality of radar level gauges 10a-g via Bluetooth.

In the system 100, radar level gauge 10a may send filling levels determined by its processing circuitry 20 directly to the gateway 102, whereas another radar level gauge 10b may send filling levels determined by its processing circuitry 20 to the gateway 102 via a neighboring radar level gauge 10c. The radar level gauge 10c hence relays determined filling levels from the radar level gauge 10b. Yet another radar level gauge could send filling levels determined by its processing circuitry 20 to the gateway 102 via more than one radar level gauge. For example, a filling level determined by radar level gauge 10c may be relayed by radar level gauges 10e and 10c to the gateway 102, etc.

The Bluetooth communication unit 24 of each radar level gauge 10 may include provisioning capability allowing the radar level gauge 10 to wirelessly join the 100 Bluetooth mesh network, e.g. new radar level gauge 10h. The provisioning procedure may comprise five phases: 1 Beaconing; 2 Invitation; 3 Exchange public keys; 4 Authentication; 5 Distribution of provisioning data. If “Output Out of Band” Authentication is used, the random number can be shown on the aforementioned display of the radar level gauge 10, or an LED on the radar level gauge 10 could blink a given number of times. For “Static Out of Band” Authentication, the serial number of the radar level gauge 10 could be used.

The gateway 102 may also be configured to convert the received determined filling levels to another communication protocol, for example FF, HART, Modbus, Modbus TCP, Profibus, Ethernet, cellular network, or OPC. The gateway 102 may further be configured to send the convert received determined filling levels to another unit or a cloud solution 106 using the another communication protocol.

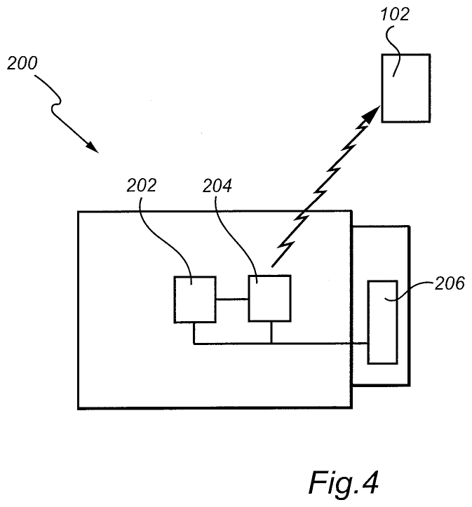

The Bluetooth mesh network 104 may also comprise at least one field device 200 which is not a radar level gauge. FIG. 4 discloses an example of the field device 200, which comprises: means 202 for determining or measuring at least one process variable; a Bluetooth communication unit 204, preferably with mesh capability, wherein the Bluetooth communication unit 204 is connected to said means 202 and configured to wirelessly send at least one determined or measured process variable to an external unit (e.g. the gateway 102) using a Bluetooth protocol; and means 204 for supplying power to said means 202 and the Bluetooth communication unit 204, wherein the Bluetooth protocol is the sole communication protocol of the field device 200, and wherein the field device 200 is devoid of any communication terminal(s) and associated components adapted to connect the device to an external communication device via at least one communication wire. The at least one process variable may be at least one of: temperature, pressure, flow rate, and pH, and said means 202 may include at least one of: a temperature gauge, a pressure gauge, a flowmeter, and a pH-meter.

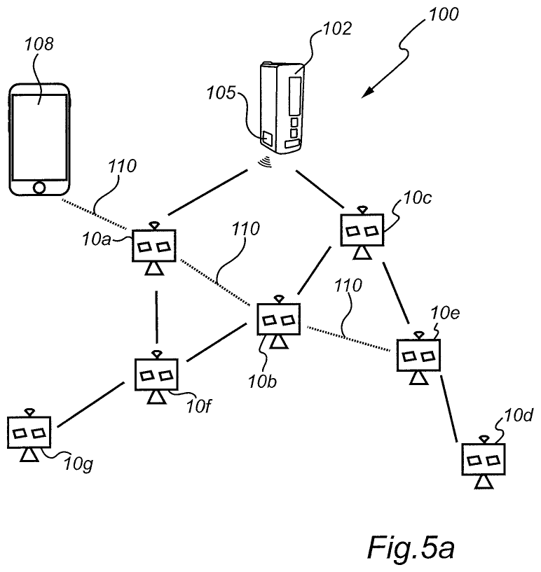

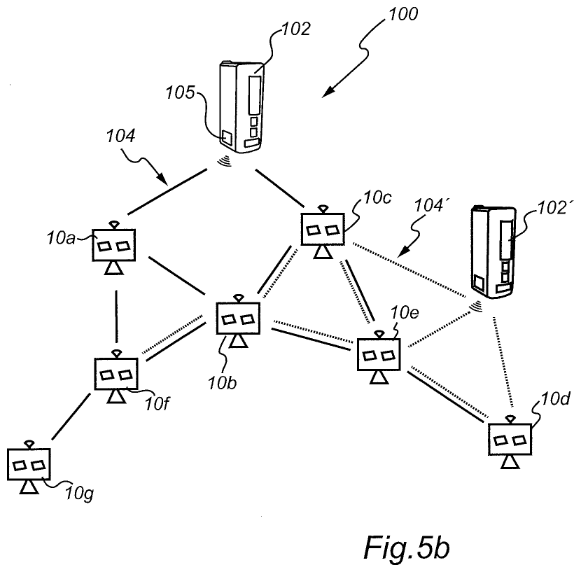

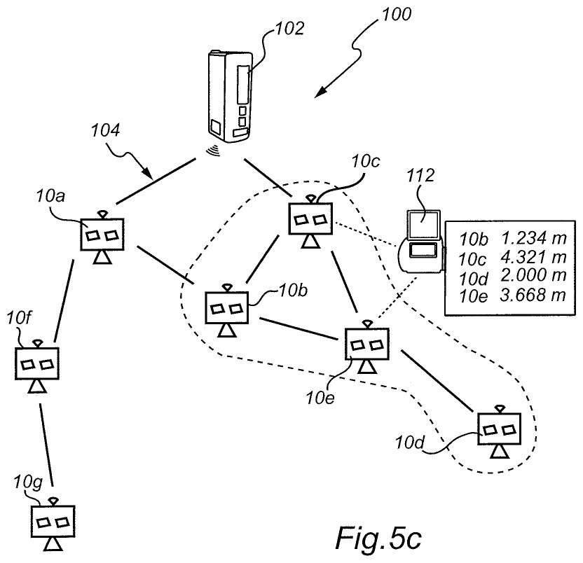

FIG. 5a shows a variant of the system 100, wherein the system 100 further comprises a mobile device 108 configured to establish a secondary temporary communication channel 110 via Bluetooth with a radar level gauge 10e in the Bluetooth mesh network 104. The mobile device may for example be a smart phone or tablet or laptop. The secondary temporary communication channel 110 is here established via two other radar level gauges 10a and 10b in the Bluetooth mesh network 104, but could alternatively be established directly with the radar level gauge 10e, for example.

FIG. 5b shows another variant of the system 100, wherein the system comprises a second gateway 102′. The second gateway 102′ may be of the same type as the aforementioned (first) gateway 102. The second gateway 102′ forms a second Bluetooth mesh network 104′ represented with dotted lines with some of the radar level gauges 10b-e of the (first) of the first Bluetooth mesh network 104. The second gateway 102′ may for example act as a redundant gateway or as a display unit. Hence, the radar level gauges connected to both Bluetooth mesh networks 104, 104′ can send determined filling levels to both gateways 102, 102′.

FIG. 5c shows yet another variant of the system 100, wherein the system 100 further comprises a passive device 112 connected via Bluetooth to the Bluetooth mesh network 104. The device 112 is passive in that it just listens to communication in the Bluetooth mesh network 104, in contrast to the gateway 102 which also could send control data and/or configuration data to the radar level gauges 10a-g. This variant may be likened to “reversed” Bluetooth advertisement, wherein one or more radar level gauges, e.g. radar level gauges 10b-e, broadcast data that the passive device 112 picks up. The passive device 112 may for example be a display unit adapted to display filling levels determined by a number of radar level gauges, e.g. radar level gauges 10b-e like in FIG. 5c.

The person skilled in the art realizes that the present invention by no means is limited to the preferred embodiments described above. On the contrary, many modifications and variations are possible within the scope of the appended claims.

There is also contemplated a radar level gauge for determining a filling level of a product in a tank, which radar level gauge only has 5G (fifth generation of broadband cellular network technology) connection for communication, i.e. no wired or other wireless communication. Such a radar level gauge with 5G may report itself to a cloud service when starting up. The radar level gauge may be assigned to the customer account who purchased the radar level gauge. The customer may sign in to his or hers account to access the radar level gauge. The customer may manage configuration of the radar level gauge using the cloud service. The customer may retrieve measurement values (determined filling levels) from the radar level gauge by accessing the cloud service.

1. A radar level gauge for determining a filling level of a product in a tank, said radar level gauge comprising:
transceiver circuitry configured to generate and transmit an electromagnetic transmit signal, and to receive an electromagnetic return signal;
processing circuitry connected to the transceiver circuitry and configured to determine the filling level based on a relationship between the transmit signal and the return signal;
a Bluetooth communication unit, wherein the Bluetooth communication unit is connected to the processing circuitry and configured to wirelessly send a determined filling level to an external unit using a Bluetooth protocol; and
means for supplying power to the transceiver circuitry, the processing circuitry and the Bluetooth communication unit,
wherein the Bluetooth protocol is the sole communication protocol of the radar level gauge, and
wherein the radar level gauge is devoid of any communication terminal(s) and associated components adapted to connect the radar level gauge to an external communication device via at least one communication wire.

2. A radar level gauge according to claim 1, wherein the Bluetooth communication unit has mesh capability.

3. A radar level gauge according to claim 1, wherein the transceiver circuitry and processing circuitry are integrated in a single integrated circuit.

4. A radar level gauge according to claim 1, wherein the Bluetooth communication unit is provided on a separate chip.

5. A radar level gauge according to claim 2, wherein the Bluetooth communication unit includes provisioning capability allowing the radar level gauge to wirelessly join a Bluetooth mesh network.

6. A radar level gauge according to claim 1, wherein the Bluetooth communication unit is a Bluetooth Low Energy, BLE, communication unit.

7. A radar level gauge according to claim 1, wherein said means for supplying power to the transceiver circuitry, processing circuitry and the Bluetooth communication unit includes a battery.

8. A system, comprising:
a gateway; and
a plurality of radar level gauges,
wherein the gateway and the plurality of radar level gauges form a Bluetooth mesh network, and
wherein each radar level gauge of the plurality of radar level gauges is adapted to determine a filling level of a product in a tank and comprises:
transceiver circuitry configured to generate and transmit an electromagnetic transmit signal, and to receive an electromagnetic return signal;
processing circuitry connected to the transceiver circuitry and configured to determine the filling level based on a relationship between the transmit signal and the return signal;
a Bluetooth communication unit with mesh capability, wherein the Bluetooth communication unit is connected to the processing circuitry and configured to wirelessly send a determined filling level to the gateway using a Bluetooth protocol, directly and/or via at least one other radar level gauge of the plurality of radar level gauges; and
means for supplying power to the transceiver circuitry, processing circuitry and the Bluetooth communication unit,
wherein the Bluetooth protocol is the sole communication protocol of the radar level gauge, and
wherein the radar level gauge is devoid of any communication terminal(s) and associated components adapted to connect the radar level gauge to an external communication device via at least one communication wire.

9. A system according to claim 8, wherein the gateway is configured to receive determined filling levels from the plurality of radar level gauges via Bluetooth, and to convert the received determined filling levels to at least one other communication protocol selected from the group comprising: FF, HART, Modbus, Modbus TCP, Profibus, Ethernet, cellular network, and OPC.

10. A system according to claim 8, further comprising a mobile device configured to establish a secondary temporary communication channel via Bluetooth with a radar level gauge of the plurality of radar level gauges.

11. A system according to claim 8, further comprising another gateway forming another Bluetooth mesh network with at least some radar level gauges of the plurality of radar level gauges.

12. A system according to claim 8, comprising a passive device connected via Bluetooth to the Bluetooth mesh network and adapted to listen to communication in the Bluetooth mesh network.

13. A method of wirelessly sending a determined filling level of a product in a tank from a radar level gauge to another unit, said radar level gauge comprising:
transceiver circuitry configured to generate and transmit an electromagnetic transmit signal, and to receive an electromagnetic return signal;
processing circuitry connected to the transceiver circuitry and configured to determine the filling level based on a relationship between the transmit signal and the return signal;
a Bluetooth communication unit, wherein the Bluetooth communication unit is connected to the processing circuitry; and
means for supplying power to the transceiver circuitry, processing circuitry and the Bluetooth communication unit,
wherein the method comprises:
by means of the Bluetooth communication unit, wirelessly sending a determined filling level to the another unit using a Bluetooth protocol,
wherein the Bluetooth protocol is the sole communication protocol of the radar level gauge, and wherein the radar level gauge is devoid of any communication terminal(s) and associated components adapted to connect the radar level gauge to an external communication device via at least one communication wire.

101-113. (canceled)
